(19) United States
(12) Patent Application Publication
(10) Pub. No.: US 2013/0062991 A1
(43) Pub. Date: Mar. 14, 2013

(54) ROTATING ELECTRIC MACHINE

(71) Applicant: ALSTOM Hydro France, Levallois-Perret (FR)

(72) Inventor: Ricardo Naoki Okai, Fislisbach (CH)

(73) Assignee: ALSTOM HYDRO FRANCE, Levallois-Perret (FR)

(21) Appl. No.: 13/672,389

(22) Filed: Nov. 8, 2012

Related U.S. Application Data
(63) Continuation of application No. PCT/EP2011/057443, filed on May 9, 2011.

(30) Foreign Application Priority Data
May 10, 2010 (DE) 102010019818.8

(51) Int. Cl. H02K 1/28

(52) U.S. Cl. CPC H02K 1/28
USPC 310/216.123

(57) ABSTRACT

A rotating electrical machine is presented and includes a rotor, rotatable about an axis and is surrounded concentrically by a stator and has a hollow cylindrical rotor laminated core, which includes a layered lamination stack made up of a multiplicity of ring-section-shaped lamination segments which are acted upon by a pressing plate in order to distribute the pressure and are clamped by bolts which pass in an axial direction through the rotor laminated core, and which engages with a concentric central body of the rotor by means of axial slots on the internal radius of the rotor laminated core in order to transmit torque. The machine also includes slots formed in each case by pairs of radially inwardly aligned cams which are arranged on the internal radius of the lamination segments and are separated from one another by the width of the slot.

### INCORPORATION BY REFERENCE

The following documents are incorporated herein by reference as if fully set forth: International Patent Application No. PCT/EP2011/057443, filed May 9, 2011—and—German Patent Application No. 102010019818.8, filed May 10, 2010.

### FIELD OF INVENTION

The present invention relates to the field of electrical machines. Specifically it relates to a rotating electrical machine.

### BACKGROUND

Doubly-fed asynchronous machines are sufficiently well known. They have a design which can be expressed as follows by way of example. The rotating electrical machine or asynchronous machine comprises a rotor which can be rotated about an axis and is surrounded concentrically by a stator. The stator has a stator winding which is accommodated in a stator laminated core and projects from the ends of the stator laminated core in the form of a stator end winding.

The rotor comprises a central body with a shaft, at the ends of which slip rings for transferring the current are arranged. A rotor laminated core, which carries a rotor winding which protrudes from the ends of the rotor laminated core in the form of a rotor end winding, extends around the central body. The rotor winding must be secured against the centrifugal forces which occur. The rotor lamination stack of the rotor laminated core serves to absorb these forces and at the same time defines the path for magnetic flux.

An auxiliary rim is arranged at the ends of the rotor laminated core. The auxiliary rim, like the rotor lamination stack, consists of laminated sheets which are pressed in the axial direction to form a composite assembly. The pressing is carried out by means of a multiplicity of bolts which extend in the axial direction through the rotor laminated core and the auxiliary rim. A pressing plate is provided between auxiliary rim and rotor laminated core or rim in order to distribute pressure.

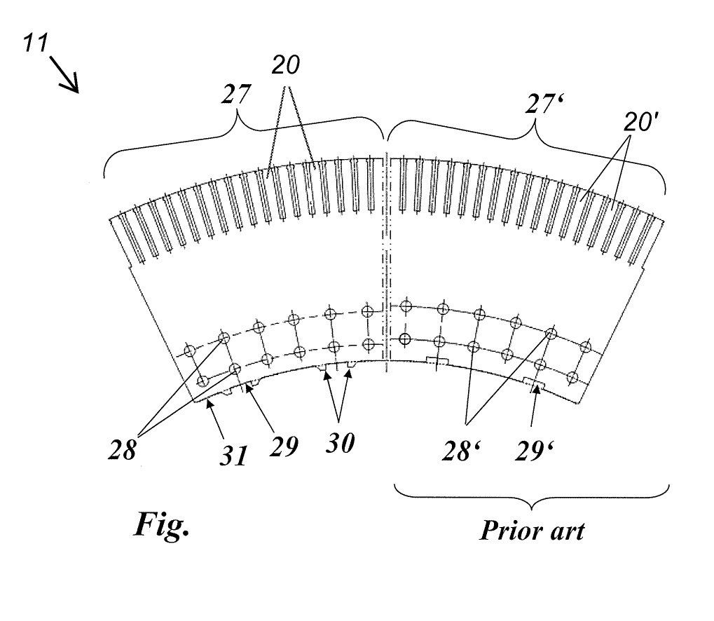

The rotor laminated core and the central body of the rotor are independent components which must engage with one another in order to transmit torques. U.S. Pat. No. 4,942,324, which is incorporated by reference as if fully set forth, (see FIG. 1 therein) discloses the provision of wedges (26), which engage in corresponding cut slots in the inner circumference of the rim (24), in order to provide coupling between the rim (24) and the hub (9). This known type of connection is reproduced in the only FIGURE of the present application in the right-hand half for the lamination segment 27′, where the slots 29′ are arranged on the inner circumference of the lamination segment 27′ for engagement between the rim and the central body.

As a result of the slots 29′, which extend in a radial direction into the lamination segments 27′ or the rim, it is necessary to move the holes 28′ for the bolts outwards in order to maintain an adequate radial distance from the slots 29′. This leads to a disadvantageous reduction in the load-bearing rim height.

### SUMMARY

The present disclosure is directed to a rotating electrical machine including a rotor, rotatable about an axis and is surrounded concentrically by a stator and has a hollow cylindrical rotor laminated core. The rotor laminated core includes a layered lamination stack which is made up of a plurality of ring-section-shaped lamination segments which are equipped with teeth on an outer edge thereof for accommodating a rotor winding and which are clamped by bolts which pass in an axial direction through the rotor laminated core and a pressing plate, and which engages with a concentric central body of the rotor by axial slots on an internal radius of the rotor laminated core in order to transmit torque. The slots are each formed by pairs of radially inwardly aligned cams which are arranged on the internal radius of the lamination segments and are separated from one another by a width of the slot.

### BRIEF DESCRIPTION OF THE DRAWING

The following detailed description of the preferred embodiment of the present invention will be better understood when read in conjunction with the appended drawing. For the purpose of illustrating the invention, there are shown in the drawings embodiments which are presently preferred. It is understood, however, that the invention is not limited to the precise arrangements and instrumentalities shown. In the drawing:

The only FIGURE shows a lamination segment for the rotor laminated core of an asynchronous machine with interlocking connection means according to an exemplary embodiment of the invention.

### DETAILED DESCRIPTION OF THE PREFERRED EMBODIMENTS

### Introduction to the Embodiments

It is therefore the object of the invention to create a rotating electrical machine of the kind mentioned in the introduction, with which disadvantageous limitations due to the mechanical connection between central body and rim are avoided.

The object is achieved by the features of the appended claims.

A fundamental feature of the proposed solution is that the slots are formed in each case by pairs of radially inwardly aligned cams which are arranged on the internal radius of the lamination segments and are separated from one another by the width of the slot. By placing the cams along the internal radius, the slots can be moved more towards the center of the rotor. This new form also allows the yoke to be increased in size, as the holes for the shear bolts can also be offset inwards without changing the internal or external radius of the lamination or rotor, and without hardly increasing the weight of the rotor laminated core. A sufficiently large air passage for the cooling is still guaranteed.

According to a preferred embodiment of the invention, the radial height of the cams is equal to the slot depth of the slots.

The cams are formed from the lamination segments by a suitable manufacturing process. Stamping or laser forming in particular are mentioned here as preferred methods.

According to a supplementary embodiment of the invention, adjacent lamination segments of the rotor lamination stack are arranged offset with respect to one another.

### DETAILED DESCRIPTION

The FIGURE shows a direct comparison of the difference between the previous solution (right-hand half of the FIGURE; prior art) and an exemplary embodiment of the solution according to the invention (left-hand half of the FIGURE).

Slots are cut in the lamination segments 27, 27′ in order to transmit torque from the central body to the rotor laminated core. The lamination segments 27, are equipped with teeth 20 on the outer edge for accommodating a rotor winding and which are clamped by means of bolts which pass in an axial direction through the rotor laminated core and a pressing plate. With the solutions according to the prior art, these slots 29′ are cut into the lamination segments 27′, which leads to a reduction in the load-bearing rim height, as can be seen from the right-hand half of the FIGURE.

By placing cams 30 along the internal radius 31, the slots 29 can be moved further inwards towards the center of the rotor 11, as can be seen from the left-hand half of the FIGURE.

This measure according to the invention allows the yoke to be increased in size, as the bores or holes 28 for the shear bolts can also be offset inwards without changing the internal or external radius of the lamination or rotor. This considerably improves the transmission of force from the central body of the rotor to the lamination stack of the rotor laminated core without at the same time having a negative influence on the cooling, and without hardly increasing the weight of the rotor laminated core.

In a manner which is known per se, the slots 29 can have a rectangular, approximately rectangular, trapezoidal or any other cross-sectional form.

The lamination segments 27 are layered within the lamination stack. That is to say, the lamination segments 27 are arranged offset with respect to one another from layer to layer. This measure serves to increase the mechanical integrity of the lamination stack and reduces the risk of buckling.

What is claimed is:

1. A rotating electrical machine comprising a rotor, rotatable about an axis and is surrounded concentrically by a stator and has a hollow cylindrical rotor laminated core, which comprises a layered lamination stack which is comprised of a plurality of ring-section-shaped lamination segments which are equipped with teeth on an outer edge thereof for accommodating a rotor winding and which are clamped by bolts which pass in an axial direction through the rotor laminated core and a pressing plate, and which engages with a concentric central body of the rotor by axial slots on an internal radius of the rotor laminated core in order to transmit torque, the slots are each formed by pairs of radially inwardly aligned cams which are arranged on the internal radius of the lamination segments and are separated from one another by a width of the slot.

2. The rotating electrical machine as claimed in claim 1, wherein a radial height of the cams is equal to a slot depth of the slots.

3. The rotating electrical machine as claimed in claim 1, wherein surfaces of respectively adjacent cams which face the slots are aligned at least approximately parallel.

4. The rotating electrical machine as claimed in claim 1, wherein the slots formed by the cams are trapezoidal.

5. The rotating electrical machine as claimed in claim 1, wherein the cams are formed by stamping out from the lamination segments.

6. The rotating electrical machine as claimed in claim 1, wherein the cams are formed from the lamination segments by a laser process.

7. The rotating electrical machine as claimed in claim 1, wherein adjacent lamination segments of the rotor laminated core are arranged offset with respect to one another.

8. The rotating electrical machine as claimed in claim 1, wherein the machine is a doubly-fed asynchronous machine in a power range from 20 MVA-500 MVA.
